(19) United States
(12) Patent Application Publication
(10) Pub. No.: US 2021/0079249 A1
(43) Pub. Date: Mar. 18, 2021

(54) PRECOAT LIQUID, IMAGE FORMING METHOD USING THE PRECOAT LIQUID, AND IMAGE FORMING APPARATUS USING THE PRECOAT LIQUID

(71) Applicant: Konica Minolta, Inc., Tokyo (JP)

(72) Inventors: Akihiro HONYA, Tokyo (JP); Yoshiyasu MATSUMOTO, Tokyo (JP); Akiko KAWAMURA, Tokyo (JP); Hiroyuki YASUKAWA, Tokyo (JP)

(21) Appl. No.: 17/000,816

(22) Filed: Aug. 24, 2020

(30) Foreign Application Priority Data
Sep. 17, 2019 (JP) 2019-168519

(51) Int. Cl. C09D 11/54; B41M 5/00; B41M 5/025; B41M 7/00; B41J 2/005; C09D 11/101; C09D 11/033; C09D 11/107; C09D 11/30

(52) U.S. Cl. CPC C09D 11/54; B41M 5/0011; B41M 5/0256; B41M 5/0023; C09D 11/30; B41J 2/0057; C09D 11/101; C09D 11/033; C09D 11/107; B41M 7/0081

(57) ABSTRACT

A precoat liquid used in an intermediate-transfer image forming method in which an actinic radiation-curable ink and an intermediate transfer member are used, the precoat liquid being applied onto a surface of the intermediate transfer member before the actinic radiation-curable ink is applied onto the surface of the intermediate transfer member, includes a water-soluble organic solvent having two or more hydroxyl groups per molecule. The water-soluble organic solvent has a C value of more than 0.03, the C value being calculated using Expression (1).

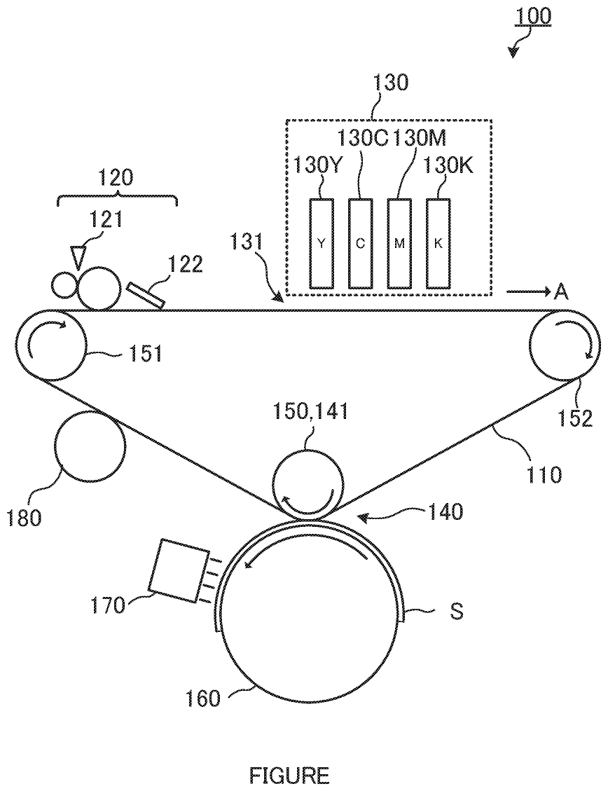

### CROSS REFERENCE TO RELATED APPLICATIONS

The entire disclosure of Japanese Patent Application No. 2019-168519 filed on Sep. 17, 2019, is incorporated herein by reference in its entirety.

### BACKGROUND

### Technological Field

The present invention relates to a precoat liquid, an image forming method using the precoat liquid, and an image forming apparatus using the precoat liquid.

### Description of Related Art

An inkjet method is an easy, simple, and low-cost image forming method and has been used in various fields of printing including various types of printing and special printing, such as marking, thin-line formation, and color filter. Since an inkjet method does not require a printing plate and enables digital printing, it is particularly suitable for forming a variety of images in small amounts.

When an image is formed on a recording medium that absorbs an ink, such as a paper sheet, by an inkjet method, part of the ink ejected from an inkjet head and impinged on the recording medium penetrates into the recording medium. Reducing the amount of ink used for forming images to lower the cost of image formation may reduce the contrast ratio of the image and increase the likelihood of formation of inconsistencies in the image. Reducing the viscosity of the ink to suppress the penetration of the ink into the recording medium and increase the likelihood of the ink spreading on the surface of the recording medium may cause the ink to spread on the recording medium in an unintended shape and makes it difficult to form a high-definition image.

In contrast, forming an intermediate image on the surface of an intermediate transfer member that is resistant to the penetration of the ink and transferring the intermediate image to a recording medium enable an image having a high contrast ratio to be formed with a smaller amount of ink and reduce the unintended spread of the ink. Consequently, high-definition images may be formed at low costs.

There have been studied methods based on the above technology, the methods including forming a precoat layer on the surface of the intermediate transfer member, applying an actinic radiation-curable ink to the precoat layer, irradiating the ink with actinic radiation to form an intermediate image.

Examples of the above methods include a method for producing recorded matter disclosed in Japanese Patent Application Laid-Open No. 2013-184342, the method including applying a first ink including a volatile liquid (e.g., monohydric alcohol) onto the surface of an intermediate transfer member permeable to actinic radiation; applying, by an inkjet method, a second ink including a colorant and a polymerizable compound onto the ink portion deposited on the surface of the intermediate transfer member; irradiating the intermediate transfer member with actinic radiation from a side of the intermediate transfer member which is opposite to the side on which the second ink is deposited to partially polymerize the polymerizable compound included in the second ink; transferring the second ink to a recording medium; and completely polymerizing the polymerizable compound included in the second ink transferred on the recording medium. In Japanese Patent Application Laid-Open No. 2013-184342, it is described that forming a coating film on the surface of the intermediate transfer member with the first ink enables the second ink deposited on the coating film to be formed into an intended shape and prevents the second ink from spreading on the surface of the intermediate transfer member to a higher degree than necessary.

Another example is a recording apparatus disclosed in Japanese Patent Application Laid-Open No. 2012-096546, the apparatus including a curable solution layer formation unit that applies a curable solution including a polymerizable compound to an intermediate transfer member to form a curable solution layer; an ink application unit that applies an ink to the curable solution layer disposed on the intermediate transfer member; a transfer unit that brings the curable solution layer on which the ink is deposited into contact with a recording medium to transfer the entire curable solution layer from the intermediate transfer member to the recording medium; and a stimulus supply unit that supplies a stimulus capable of curing the curable solution layer to the curable solution layer. It is described in Japanese Patent Application Laid-Open No. 2012-096546 that starting the supply of the stimulus (e.g., irradiation with ultraviolet radiation) after the curable layer disposed on the intermediate transfer member has come into contact with the recording medium, finishing the supply of the stimulus before the curable layer is detached from the intermediate transfer member, and then detaching the curable layer from the intermediate transfer member may reduce the likelihood of liquid separation occurring when the curable layer is detached from the intermediate transfer member and enhance transferability.

### SUMMARY

The present invention was made in light of the above issues. An object of the present invention is to provide a precoat liquid incompatible with an ink and an image forming method and an image forming apparatus that achieve high transferability and are capable of forming high-definition images by using the precoat liquid.

To achieve at least one of the abovementioned objects, according to an aspect of the present invention, a precoat liquid reflecting one aspect of the present invention is a precoat liquid used in an intermediate-transfer image forming method in which an actinic radiation-curable ink and an intermediate transfer member are used, the precoat liquid being applied onto a surface of the intermediate transfer member before the actinic radiation-curable ink is applied onto the surface of the intermediate transfer member, the precoat liquid comprising a water-soluble organic solvent having two or more hydroxyl groups per molecule. The water-soluble organic solvent has a C value of more than 0.03, the C value being calculated using Expression (1) below.

C=[Number of hydroxyl groups per molecule]²/[Molecular weight] (1)

An image forming method reflecting another aspect of the present invention comprises applying a precoat liquid onto a surface of an intermediate transfer member; applying an actinic radiation-curable ink onto the surface of the intermediate transfer member, the surface of the intermediate transfer member including the precoat liquid deposited thereon; transferring the actinic radiation-curable ink deposited on the surface of the intermediate transfer member to a recording medium; and curing the actinic radiation-curable ink transferred on the recording medium. The precoat liquid includes a water-soluble organic solvent having two or more hydroxyl groups per molecule. The water-soluble organic solvent has a C value of more than 0.03, the C value being calculated using Expression (1) below.

C=[Number of hydroxyl groups per molecule]²/[Molecular weight] (1)

An image forming apparatus reflecting still another aspect of the present invention comprises an intermediate transfer member; a precoat liquid application unit that applies a precoat liquid onto a surface of the intermediate transfer member; an ink application unit that applies an actinic radiation-curable ink onto the surface of the intermediate transfer member, the surface of the intermediate transfer member including the precoat liquid deposited thereon; a transfer unit that transfers the actinic radiation-curable ink deposited on the surface of the intermediate transfer member to a recording medium; and a fixing unit that cures the actinic radiation-curable ink transferred on the recording medium. The precoat liquid includes a water-soluble organic solvent having two or more hydroxyl groups per molecule. The water-soluble organic solvent has a C value of more than 0.03, the C value being calculated using Expression (1) below.

C=[Number of hydroxyl groups per molecule]²/[Molecular weight] (1)

### BRIEF DESCRIPTION OF DRAWING

The advantageous and features provided by one or more embodiments of the invention will become more fully understood from the detailed description given hereinbelow and the appended drawing which are given by way of illustration only, and thus are not intended as a definition of the limits of the present invention:

FIGURE is a schematic diagram illustrating the structure of an image forming apparatus required for implementing an image forming method according to an embodiment of the present invention.

### DETAILED DESCRIPTION OF EMBODIMENTS

Hereinafter, one or more embodiments of the present invention will be described with reference to the drawing. However, the scope of the invention is not limited to the disclosed embodiments.

### 1. Precoat Liquid

A precoat liquid according to an embodiment of the present invention is applied onto the surface of an intermediate transfer member before an actinic radiation-curable ink is applied onto the surface of the intermediate transfer member. The precoat liquid makes it easy to detach an intermediate image (i.e., the actinic radiation-curable ink) from the surface of the intermediate transfer member when the intermediate image is transferred to a recording medium. The precoat liquid includes a water-soluble organic solvent. The water-soluble organic solvent included in the precoat liquid has two or more hydroxyl groups per molecule and a C value of more than 0.03, the C value being calculated using Expression (1) below. The C value of the water-soluble organic solvent is determined on the basis of weight-average molecular weight Mw measured by gel permeation chromatography (GPC) and the number of hydroxyl groups measured by infrared spectroscopy (IR).

C=[Number of hydroxyl groups per molecule]²/[Molecular weight] (1)

The precoat liquid may further include a modifier for adjustment of surface tension and viscosity. Each of the constituents of the precoat liquid is described below.

### 1-1. Water-Soluble Organic Solvent

The precoat liquid according to the embodiment of the present invention includes a water-soluble organic solvent. The water-soluble organic solvent has two or more hydroxyl groups per molecule and a C value of more than 0.03, the C value being calculated using Expression (1) below. The water-soluble organic solvent more preferably has three or more hydroxyl groups per molecule. Using a water-soluble organic solvent having three or more hydroxyl groups per molecule may further enhance the hydrophilicity of the precoat liquid and thereby reduce the compatibility of the precoat liquid with the actinic radiation-curable ink described below.

The C value calculated using Expression (1) above is preferably more than 0.03 and 0.2 or less and is more preferably 0.05 or more and 0.15 or less. When the C value of the water-soluble organic solvent included in the precoat liquid is more than 0.03, the precoat liquid has high hydrophilicity, which reduces the compatibility of the precoat liquid with the actinic radiation-curable ink.

Examples of the water-soluble organic solvent having two or more hydroxyl groups per molecule include water-soluble organic solvents having the structure represent by General Formula (1) or (2) below.

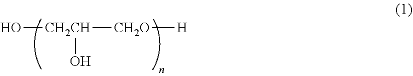

In Formula (1), n represents the degree of polymerization and is an integer of 1 to 10.

HO—R—OH (2)

In Formula (2), R is a linear or branched alkyl group having 2 to 6 carbon atoms or a linear or branched alkyl group having 2 to 6 carbon atoms and an ether group.

The degree n of polymerization of the water-soluble organic solvent represented by General Formula (1) is preferably 1 or more and 5 or less and is more preferably 2 or more and 5 or less. When the degree n of polymerization falls within the above range, the C value of the water-soluble organic solvent calculated using Expression (1) above falls within the above range of the C value.

Examples of a water-soluble organic solvent having the structure represented by General Formula (1) above include glycerin, diglycerin, and polyglycerin. Examples of a water-soluble organic solvent having the structure represented by General Formula (2) above include 1,3-propanediol, 1,5-pentanediol, propylene glycol, diethylene glycol, ethylene glycol, dipropylene glycol, polyethylene glycol, polypropylene glycol, 1,3-butanediol, 1,4-butanediol, 2,3-butanediol, 3-methyl-1,5-pentanediol, 2-methyl-2,4-pentanediol, and 2,2-dimethyl-1,3-propanediol.

Among the above water-soluble organic solvents, 1,3-propanediol and glycerin are preferable, and diglycerin and polyglycerin are more preferable. Using the water-soluble organic solvent having two or more hydroxyl groups per molecule which is represented by General Formula (1) or (2) enhances the hydrophilicity of the precoat liquid and thereby reduces the compatibility of the precoat liquid with the actinic radiation-curable ink described below. This reduces the likelihood of the actinic radiation-curable ink spreading on the surface of the precoat liquid to an excessive degree when the actinic radiation-curable ink is applied onto the surface of the precoat liquid.

The amount of the precoat liquid deposited on the surface of the intermediate transfer member is preferably 1 g/m² or more and 50 g/m² or less and is more preferably 2 g/m² or more and 30 g/m² or less. Setting the above amount of the precoat liquid to be 1 g/m² or more enables the actinic radiation-curable ink to spread to a sufficient degree and further enhances the transferability of the actinic radiation-curable ink. Setting the above amount of the precoat liquid to be 50 g/m² or less limits degradation of transferability or the like which may occur as a result of droplets of the actinic radiation-curable ink becoming buried in the precoat liquid.

### 1-2. Modifier

The precoat liquid according to the embodiment of the present invention may include a modifier for adjustment of surface tension and viscosity. Examples of the modifier include a surfactant and a hydrophilic high-molecular weight compound.

Surfactant

Examples of the surfactant include anionic surfactants, such as a dialkyl sulfosuccinate salt, an alkyl naphthalenesulfonate salt, and a fatty acid salt; nonionic surfactants, such as a polyoxyethylene alkyl ether, a polyoxyethylene alkyl allyl ether, an acetylene glycol, and a polyoxyethylene-polyoxypropylene block copolymer; cationic surfactants, such as an alkylamine salt and a quaternary ammonium salt; silicone surfactants; and fluorine-containing surfactants. Among the above surfactants, a polyoxyethylene alkyl allyl ether is preferable.

The content of the modifier in the precoat liquid is preferably 0.005% by mass or more and less than 1.0% by mass and is more preferably 0.01% by mass or more and 0.2% by mass or less of the total mass of the precoat liquid.

1-3. Physical Properties of Precoat Liquid

The surface tension of the precoat liquid according to the embodiment is preferably 30 mN/m or more and 70 mN/m or less, is more preferably 35 mN/m or more and 65 mN/m or less, and is further preferably 40 mN/m or more and 65 mN/m or less. The precoat liquid preferably has a higher surface tension than the actinic radiation-curable ink. The term “surface tension” used herein refer to a surface tension measured by the Wilhelmy method (i.e., “plate method” or “vertical plate method”) using a platinum plate.

The surface tension is calculated as r=F/(L cos θ), where F [mN] is the force required for vertically holding a platinum plate at 23° C. such that the lower end of the plate is in contact with the precoat liquid, L [m] is the peripheral length of a portion of the platinum plate which is in contact with the precoat liquid, and θ is the angle of contact of the platinum plate with the precoat liquid.

Setting the surface tension of the precoat liquid to fall within the above range enables droplets of the actinic radiation-curable ink to spread on the surface of the precoat liquid to an adequate degree and have adequate dot diameters. This increases the contrast ratio of the resulting image, reduces inconsistencies in the image, and enables the formation of high-definition images.

The solubility parameter (SP) of the precoat liquid is preferably 25 or more and is more preferably 26 or more and 40 or less. Setting the solubility parameter (SP) of the precoat liquid to be 25 or more further reduces the compatibility of the precoat liquid with the actinic radiation-curable ink and consequently limits the intrusion of an actinic radiation-polymerizable compound included in the actinic radiation-curable ink into the precoat liquid. This limits the degradation of image quality which may occur due to the compatibilization of the precoat liquid with droplets of the actinic radiation-curable ink.

Solubility parameter (SP) is calculated using the software “HSPiP” (Hansen solubility parameter (HSP)). Hansen solubility parameter is determined by considering solubility parameter (SP) as a three-dimensional vector consisting of three components, that is, a dispersion term (dD), a polarity term (dP), and a hydrogen bonding term (dH). HSP, which is inherent to a substance, is defined by the following formula. The above concept proposed by Hansen is described in Hiroshi Yamamoto, Steven Abbott, and Charles M. Hansen, Chemical Industry, March 2010, Kagaku Kogyo Sha.

HSP=(dD²+dP²+dH²)^{1/2}

dD: Dispersion term

dP: Polarity term

dH: Hydrogen bonding term

The viscosity of the precoat liquid at 20° C. is preferably 1,000 cPs or more and 10,000 cPs or less. Setting the viscosity of the precoat liquid to be 1,000 cPs or more reduces the likelihood of the precoat liquid onto which the actinic radiation-curable ink is applied spreading so as to follow the spread of the actinic radiation-curable ink and thereby enables the ink droplets to have adequate sizes. This increases the contrast ratio of the resulting image, reduces inconsistencies in the image, and enables the formation of high-definition images. The viscosity of the precoat liquid at 20° C. may be measured using a stress-controlled rheometer “Physica MCR301” produced by Anton Paar (cone plate diameter: 75 mm, cone angle: 1.0°).

Applying the precoat liquid onto the entire surface of the intermediate transfer member before the actinic radiation-curable ink is applied onto the surface of the intermediate transfer member makes it easy to detach an intermediate image from the surface of the intermediate transfer member when the intermediate image is transferred to a recording medium.

### 2. Actinic Radiation-Curable Ink

The actinic radiation-curable ink according to the embodiment is an ink that includes an actinic radiation-polymerizable compound and cures as a result of the polymerization and crosslinking of the actinic radiation-polymerizable compound occurring when the ink is irradiated with actinic radiation. The actinic radiation-curable ink may optionally include, for example, a polymerization initiator, a gelling agent, a polymerization inhibitor, a colorant, such as a dye or a pigment, a dispersant used for dispersing a pigment, a fixing resin used for fixing a pigment to a substrate, a surfactant, a pH adjuster, a humectant, and an ultraviolet absorber. The other constituents described above may be added to the composition alone or in combination of two or more.

### 2-1. Actinic Radiation-Polymerizable Compound

The actinic radiation-polymerizable compound is a compound that undergoes crosslinking or polymerization when irradiated with actinic radiation. Examples of the actinic radiation include an electron beam, ultraviolet radiation, an α-ray, a γ-ray, and an X-ray. Among the types of actinic radiation described above, ultraviolet radiation and an electron beam are preferable, and ultraviolet radiation is more preferable. Examples of the actinic radiation-polymerizable compound include a radical polymerizable compound, a cationic polymerizable compound, and a mixture thereof. Among the above actinic radiation-polymerizable compounds, a radical polymerizable compound is preferable. The actinic radiation-polymerizable compound may be any of a monomer, a polymerizable oligomer, a prepolymer, and a mixture thereof.

A radical polymerizable compound is a compound having an ethylenically unsaturated double bond group in the molecule. The radical polymerizable compound may be a monofunctional or multifunctional compound. Examples of the radical polymerizable compound include a (meth)acrylate, which is an unsaturated carboxylate ester compound. The term “(meth)acrylate” used herein refers to acrylate or methacrylate. The term “(meth)acryloyl group” used herein refers to acryloyl group or methacryloyl group. The term “(meth)acrylic” used herein refers to acrylic or methacrylic.

Examples of monofunctional (meth)acrylates include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinate, 2-(meth)acryloyloxyethyl phthalate, 2-(meth)acryloyloxyethyl-2-hydroxyethyl-phthalate, and t-butylcyclohexyl (meth)acrylate.

Examples of multifunctional (meth)acrylates include difunctional (meth)acrylates, such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-PO adduct di(meth)acrylate, neopentyl glycol hydroxypivalate di(meth)acrylate, polytetramethylene glycol di(meth)acrylate, polyethylene glycol diacrylate, and tripropylene glycol diacrylate; trifunctional (meth)acrylates, such as trimethylolpropane tri(meth)acrylate and pentaerythritol tri(meth)acrylate; polyfunctional (meth)acrylates with a valence of three or more, such as pentaerythritol tetra(meth)acrylate, dipentaerythritol hexa(meth)acrylate, ditrimethylolpropane tetra(meth)acrylate, glyceryl propoxy tri(meth)acrylate, and pentaerythritol ethoxy tetra(meth)acrylate; oligomers having a (meth)acryloyl group, such as a polyester acrylate oligomer; and compounds produced by modifying the above (meth)acrylates. Examples of the modified (meth)acrylates include an ethylene oxide-modified (EO-modified) acrylate produced by the addition of an ethylene oxide group and a propylene oxide-modified (PO-modified) acrylate produced by the addition of a propylene oxide group.

The cationic polymerizable compound is a compound having a cationic polymerizable group in the molecule. Examples of the cationic polymerizable compound include an epoxy compound, a vinyl ether compound, and an oxetane compound.

Examples of the epoxy compound include alicyclic epoxy resins, such as 3,4-epoxycyclohexylmethyl 3′,4′-epoxycyclohexanecarboxylate, bis(3,4-epoxycyclohexylmethyl) adipate, vinylcyclohexene monoepoxide, ε-caprolactone-modified 3,4-epoxycyclohexylmethyl 3′,4′-epoxycyclohexanecarboxylate, 1-methyl-4-(2-methyloxiranyl)-7-oxabicyclo[4,1,0]heptane, 2-(3,4-epoxycyclohexyl-5,5-spiro-3,4-epoxy)cyclohexanone-meth-dioxane, and bis(2,3-epoxycyclopentyl) ether; aliphatic epoxy compounds, such as the diglycidyl ether of 1,4-butanediol, the diglycidyl ether of 1,6-hexanediol, the triglycidyl ether of glycerin, the triglycidyl ether of trimethylolpropane, the diglycidyl ether of polyethylene glycol, the diglycidyl ether of propylene glycol, and a polyglycidyl ether of polyether polyol which is produced by adding one or more alkylene oxides (e.g., ethylene oxide and propylene oxide) to an aliphatic polyhydric alcohol, such as ethylene glycol, propylene glycol, or glycerin; and aromatic epoxy compounds, such as the diglycidyl or polyglycidyl ether of bisphenol A or an alkylene oxide adduct of bisphenol A, the diglycidyl or polyglycidyl ether of hydrogenated bisphenol A or an alkylene oxide adduct of hydrogenated bisphenol A, and a novolac epoxy resin.

Examples of the vinyl ether compound include monovinyl ether compounds, such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether; and divinyl or trivinyl ether compounds, such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

Examples of the oxetane compound include 3-hydroxymethyl-3-methyloxetane, 3-hydroxymethyl-3-ethyloxetane, 3-hydroxymethyl-3-propyloxetane, 3-hydroxymethyl-3-n-butyloxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyloxetane, 1,4-bis{[(3-ethyl-3-oxetanyl)methoxy]methyl}benzene, 3-ethyl-3-(2-ethylhexyloxymethyl)oxetane, and di[1-ethyl(3-oxetanyl)]methyl ether.

Among the above radical polymerizable compounds and the above cationic polymerizable compounds, the acrylic monomers are preferable.

The content of the actinic radiation-polymerizable compound in the actinic radiation-curable ink is, for example, preferably 1.0% by mass or more and 97% by mass or less and is more preferably 30% by mass or more and 90% by mass or less of the total mass of the actinic radiation-curable ink.

### 2-2. Polymerization Initiator

The actinic radiation-curable ink according to the embodiment may include a polymerization initiator. The polymerization initiator may be any substance that causes the initiation of the actinic radiation-polymerizable compound when irradiated with actinic radiation. For example, in the case where the actinic radiation-curable ink includes a radical polymerizable compound, a photo-radical initiator may be used as a polymerization initiator. In the case where the actinic radiation-curable ink is a cationic polymerizable compound, a photo-cationic initiator (e.g., photo-acid generator) may be used as a polymerization initiator.

Examples of radical polymerization initiators include an intramolecular bond cleavage-type radical polymerization initiator and an intramolecular hydrogen abstraction-type radical polymerization initiator.

Examples of the intramolecular bond cleavage-type radical polymerization initiator include acetophenone initiators, such as diethoxy acetophenone, 2-hydroxy-2-methyl-1-phenylpropan-1-one, benzil dimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl phenyl ketone, 2-methyl-2-morpholino(4-methylthiophenyl)propan-1-one, and 2-benzyl-2-dimethylamino-1-(4-morpholinophenyl)-butanone; benzoin initiators, such as benzoin, benzoin methyl ether, and benzoin isopropyl ether; acylphosphine oxide initiators, such as 2,4,6-trimethylbenzoin diphenylphosphine oxide; and benzil and methyl phenylglyoxy ester.

Examples of the intramolecular hydrogen abstraction-type radical polymerization initiator include benzophenone initiators, such as benzophenone, methyl o-benzoylbenzoate, 4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl)benzophenone, and 3,3′-dimethyl-4-methoxybenzophenone; thioxanthone initiators, such as 2-isopropylthioxanthone, 2,4-dimethylthioxanthone, 2,4-diethylthioxanthone, and 2,4-dichlorothioxanthone; aminobenzophenone initiators, such as Michler's ketone and 4,4′-diethylaminobenzophenone; and 10-butyl-2-chloroacridone, 2-ethylanthraquinone, 9,10-phenanthrenequinone, and camphorquinone.

Examples of cationic polymerization initiators include a photo-acid generator. Examples of the photo-acid generator include a B(C₆F₅)₄⁻, PF₆⁻, AsF₆⁻, SbF₆⁻, or CF₃SO₃⁻ salt of an aromatic onium compound, such as diazonium, ammonium, iodonium, sulfonium, or phosphonium; a sulfonate that generates sulfonic acid; a halide that generates hydrogen halide when irradiated with light; and an iron arene complex.

### 2-3. Gelling Agent

The actinic radiation-curable ink according to the embodiment may include a gelling agent. The gelling agent is an organic substance that is solid at normal temperature and turns to liquid when heated and thereby causes the sol-gel phase transition of the actinic radiation-curable ink depending on temperature.

The gelling agent preferably becomes crystalized in the ink at a temperature equal to or lower than the gelation temperature of the ink. The term “gelation temperature” used herein refers to the temperature at which the phase of the ink changes from sol to gel and the viscosity of the ink suddenly changes when the ink solated or liquefied by heating is cooled. Specifically, after the ink has been solated or liquefied, the ink is cooled while the viscosity of the ink is measured with, for example, a rheometer “MCR300” produced by Anton Paar. The temperature at which the viscosity of the ink suddenly increases is considered the gelation temperature of the ink.

When the gelling agent becomes crystalized in the ink, a structure including a three-dimensional space defined by the gelling agent and wax crystalized in the shape of plates and the actinic radiation-polymerizable compound housed in the space may be formed (hereinafter, the above structure is referred to as “card house structure”). When the card house structure is formed, the liquid actinic radiation-polymerizable compound is held inside the above space. This further reduces the spread of the dots formed by the ink and thereby further increases the degree of pinning of the ink. The increase in the degree of pinning of the ink results in a reduction in the combining of the dots formed by the ink deposited on a recording medium.

Examples of the gelling agent include aliphatic ketone waxes, such as dipentadecyl ketone, diheptadecyl ketone, dilignoceryl ketone, dibehenyl ketone, distearyl ketone, dieicosyl ketone, dipalmityl ketone, dimyristyl ketone, lauryl myristyl ketone, lauryl palmityl ketone, myristyl palmityl ketone, myristyl stearyl ketone, myristyl behenyl ketone, palmityl stearyl ketone, palmityl behenyl ketone, and stearyl behenyl ketone; aliphatic ester waxes, such as cetyl palmitate, stearyl stearate, behenyl behenate, icosyl icosanoate, behenyl stearate, palmityl stearate, lauryl stearate, stearyl palmitate, myristyl myristate, cetyl myristate, octyldodecyl myristate, stearyl oleate, stearyl erucate, stearyl linoleate, behenyl oleate, and arachidyl linoleate; amide compounds, such as N-lauroyl-L-glutamic acid dibutylamide and N-(2-ethylhexanoyl)-L-glutamic acid dibutylamide; dibenzylidene sorbitols, such as 1,3:2,4-bis-O-benzylidene-D-glucitol; petroleum-derived waxes, such as a paraffin wax, a microcrystalline wax, and petrolatum; plant waxes, such as a candelilla wax, a carnauba wax, a rice bran wax, a Japan wax, a jojoba oil, a jojoba solid wax, and a jojoba ester; animal waxes, such as beeswax, lanoline, and spermaceti; mineral waxes, such as a montan wax and a hydrogenated wax; a hydrogenated castor oil and a derivative of a hydrogenated castor oil; modified waxes, such as derivatives of a montan wax, a paraffin wax, a microcrystalline wax, and a polyethylene wax; higher fatty acids, such as behenic acid, arachidic acid, stearic acid, palmitic acid, myristic acid, lauric acid, oleic acid, and erucic acid; higher alcohols, such as stearyl alcohol and behenyl alcohol; hydroxystearic acids, such as 12-hydroxystearic acid; derivatives of 12-hydroxystearic acid; fatty acid amides, such as lauramide, stearamide, behenamide, oleamide, erucamide, ricinolamide, and 12-hydroxystearamide; N-substituted fatty acid amides, such as N-stearyl stearamide and N-oleyl palmitamide; special fatty acid amides, such as N,N′-ethylene bisstearamide, N,N′-ethylene bis-12-hydroxystearamide, and N,N′-xylylene bisstearamide; higher amines, such as dodecylamine, tetradecylamine, and octadecylamine; fatty acid ester compounds, such as stearyl stearate, oleyl palmitate, glycerin fatty acid ester, sorbitan fatty acid ester, propylene glycol fatty acid ester, ethylene glycol fatty acid ester, and polyoxyethylene fatty acid ester; sucrose fatty acid esters, such as sucrose stearate and sucrose palmitate; synthetic waxes, such as a polyethylene wax and an α-olefin-maleic anhydride copolymer wax; polymerizable waxes; dimer acids; and dimer diols. The above waxes may be used alone or in combination of two or more.

Among these, in order to increase the degree of pinning of the ink, an aliphatic ketone wax, an aliphatic ester wax, a higher fatty acid, a higher alcohol, and a fatty acid amide are preferable. An aliphatic ketone wax and an aliphatic ester wax in which the number of carbon atoms included in the two carbon chains located on the respective sides of the molecule across a keto or ester group is 9 or more and 25 or less are more preferable.

The content of the gelling agent in the actinic radiation-curable ink is preferably 0.5% by mass or more and less than 10.0% by mass, is more preferably 1.0% by mass or more and less than 10.0% by mass, and is further preferably 2.0% by mass or more and 7.0% by mass or less of the total mass of the actinic radiation-curable ink.

### 2-4. Polymerization Inhibitor

The actinic radiation-curable ink may include a polymerization inhibitor.

Examples of the polymerization inhibitor include an (alkyl)phenol, hydroquinone, catechol, resorcine, p-methoxyphenol, t-butylcatechol, t-butylhydroquinone, pyrogallol, 1,1-piclylhydrazyl, phenothiazine, p-benzoquinone, nitrosobenzene, 2,5-di-t-butyl-p-benzoquinone, dithiobenzoyl disulfide, picric acid, cupferron, aluminum N-nitroso phenylhydroxylamine, tri-p-nitrophenylmethyl, N-(3-oxyanilino-1,3-dimethylbutylidene)aniline oxide, dibutylcresol, cyclohexanone oxime cresol, guaiacol, o-isopropylphenol, butyraldoxime, methyl ethyl ketoxime, and cyclohexanone oxime.

The content of the polymerization inhibitor in the actinic radiation-curable ink may be 0.05% by mass or more and 0.2% by mass or less of the total mass of the ink.

### 2-5. Colorant

The actinic radiation-curable ink may include a colorant. Examples of the colorant include a pigment and a dye. The colorant is preferably a pigment in order to further enhance the dispersion stability of the actinic radiation-curable ink and form an image having high weather resistance. Examples of the pigment include an organic pigment and an inorganic pigment. Examples of the dye include various oil-soluble dyes.

The pigment may be selected from, for example, the red or magenta pigments, the yellow pigments, the green pigments, the blue or cyan pigments, and the black pigments described in Color Index in accordance with the color of the image that is to be formed.

The content of the pigment or dye in the actinic radiation-curable ink is preferably 0.1% by mass or more and 20.0% by mass or less and is more preferably 0.4% by mass or more and 10.0% by mass or less of the total mass of the ink. When the content of the pigment or dye in the ink is 0.1% by mass or more of the total mass of the ink, the intensity of the color of the resulting image may be sufficiently high. When the content of the pigment or dye in the ink is 20.0% by mass or less of the total mass of the ink, the viscosity of the ink is not excessively high.

### 2-6. Dispersant

The pigment may be dispersed in the actinic radiation-curable ink with a dispersant. The dispersant may be any substance with which the pigment can be dispersed in the ink at a sufficient degree. Examples of the dispersant include a hydroxyl group-containing carboxylate ester, a long-chain polyaminoamide salt of a high-molecular weight acid ester, a salt of a high-molecular weight polycarboxylic acid, a long-chain polyaminoamide salt of a polar acid ester, a high-molecular weight unsaturated acid ester, a high-molecular weight copolymer, a modified polyurethane, a modified polyacrylate, a polyether ester anionic activator, a naphthalenesulfonic acid formalin condensate salt, an aromatic sulfonic acid formalin condensate salt, a polyoxyethylene alkyl phosphate ester, a polyoxyethylene nonylphenyl ether, and stearylamine acetate.

### 2-7. Fixing Resin

The actinic radiation-curable ink may include a fixing resin in order to further enhance the rubfastness and blocking resistance of the coating film.

Examples of the fixing resin include a (meth)acrylic resin, an epoxy resin, a polysiloxane resin, a maleic acid resin, a vinyl resin, a polyamide resin, nitrocellulose, cellulose acetate, ethylcellulose, an ethylene-vinyl acetate copolymer, a urethane resin, a polyester resin, and an alkyd resin.

The content of the fixing resin in the actinic radiation-curable ink is, for example, 1.0% by mass or more and 10.0% by mass or less of the total mass of the actinic radiation-polymerizable compound.

### 2-8. Surfactant

The actinic radiation-curable ink may include a surfactant.

The surfactant adjusts the surface tension of the ink, thereby adjusts the wettability of the ink on the substrate, and suppresses the combining of neighboring droplets.

Examples of the surfactant include a silicone surfactant, an acetylene glycol surfactant, and a fluorine-containing surfactant having a perfluoroalkenyl group.

The content of the surfactant in the actinic radiation-curable ink is 0.001% by mass or more and 10% by mass or less and is more preferably 0.001% by mass or more and 1.0% by mass or less of the total mass of the actinic radiation-curable ink.

### 2-9. Other Constituents

The actinic radiation-curable ink may optionally further include a polysaccharide, a viscosity modifier, a specific-resistance modifier, a coating-forming agent, an ultraviolet absorber, an antioxidant, a color-fading inhibitor, an antifungal agent, an anticorrosive, and the like.

2-10. Physical Properties of Actinic Radiation-Curable Ink

The viscosity of the actinic radiation-curable ink at 40° C. is preferably 1×10³ mPa·s or more and less than 5×10⁴ mPa·s and is more preferably 3×10³ mPa·s or more and less than 1×10⁴ mPa·s. When the viscosity of the actinic radiation-curable ink at a temperature equal to the temperature of the intermediate transfer member at the time when the ink is applied to the intermediate transfer member is 1×10³ mPa·s or more, the droplets of the actinic radiation-curable ink deposited on the intermediate transfer member are less likely to spread and combine with one another. When the viscosity of the actinic radiation-curable ink at the above temperature is less than 5×10⁴ mPa·s, the actinic radiation-curable ink may be readily ejected through an inkjet head.

In order to increase the ease of the ejection of the ink through an inkjet head, the viscosity of the actinic radiation-curable ink at 40° C. is preferably 3 mPa·s or more and 20 mPa·s or less in the case where the actinic radiation-curable ink does not include the gelling agent. In the case where the actinic radiation-curable ink includes the gelling agent, the viscosity of the actinic radiation-curable ink at 80° C. is preferably 3 mPa·s or more and 20 mPa·s or less. When the viscosity of the actinic radiation-curable ink at 80° C. is 3 mPa·s or more and 20 mPa·s or less, the actinic radiation-curable ink is less likely to undergo gelation when the actinic radiation-curable ink is ejected through an inkjet head and, consequently, the actinic radiation-curable ink may be ejected through an inkjet head with further consistency. In the case where the actinic radiation-curable ink includes the gelling agent, the viscosity of the actinic radiation-curable ink at 25° C. is preferably 1,000 mPa·s or more in order to cause the ink impinged on the intermediate transfer member to undergo gelation to a sufficient degree when the temperature is reduced to normal temperature. When the viscosity of the actinic radiation-curable ink at 25° C. is 1,000 mPa·s or more, the ink droplets deposited on the intermediate transfer member are less likely to spread and combine with one another.

The viscosities of the actinic radiation-curable ink at 40° C. and 80° C. are measured by heating the actinic radiation-curable ink to 100° C. with a rheometer, measuring the viscosity of the ink with a stress-controlled rheometer “Physica MCR301” produced by Anton Paar (cone plate diameter: 75 mm, cone angle: 1.0°) while cooling the ink to 40° C. with a shear rate of 11.7 l/s at a cooling rate of 0.1° C./s, and reading the viscosity values corresponding to 40° C. and 80° C. from the resulting viscosity-temperature relation curve.

The surface tension of the actinic radiation-curable ink is preferably 20 mN/m or more and 40 mN/m or less and is more preferably 25 mN/m or more and 38 mN/m or less. The actinic radiation-curable ink preferably has a lower surface tension than the precoat liquid. Setting the surface tension of the actinic radiation-curable ink to be lower than that of the precoat liquid enables the actinic radiation-curable ink to spread on the surface of the precoat liquid to an adequate degree. The surface tension of the actinic radiation-curable ink may be measured by the same method as in the measurement of the surface tension of the precoat liquid.

The solubility parameter (SP) of the actinic radiation-curable ink is preferably 15 or more and 20 or less. Setting the solubility parameter (SP) of the actinic radiation-curable ink to be 15 or more and 20 or less reduces the compatibilization of the actinic radiation-curable ink with the liquid precoat layer and consequently limits the intrusion of the actinic radiation-polymerizable compound included in the actinic radiation-curable ink into the precoat liquid. This limits the degradation of image quality which may occur due to the compatibilization of the precoat liquid with droplets of the actinic radiation-curable ink. In the case where a (meth)acrylate is used as an actinic radiation-polymerizable compound, the SP of the actinic radiation-curable ink may be set to 15 or more and 20 or less and the compatibilization of the actinic radiation-curable ink with the precoat liquid may be markedly reduced.

### 2-11. Method for Preparing Actinic Radiation-Curable Ink

The actinic radiation-curable ink may be prepared by mixing the actinic radiation-polymerizable compound with the polymerization initiator, the polymerization inhibitor, the colorant, and the other optional constituents while they are heated. The resulting liquid mixture is preferably passed through a predetermined filter. In the case where an ink including a pigment is prepared, it is preferable to prepare a pigment dispersion containing the pigment and the actinic radiation-polymerizable compound and subsequently mix the pigment dispersion with the other constituents. The pigment dispersion may further contain a dispersant.

The pigment dispersion may be prepared by dispersing the pigment in the actinic radiation-polymerizable compound. For dispersing the pigment, for example, a ball mill, a sand mill, an Attritor, a roll mill, an agitator, a Henschel mixer, a colloid mill, an ultrasonic homogenizer, a pearl mill, a wet jet mill, a paint shaker, and the like may be used. For dispersing the pigment, a dispersant may be used.

### 3. Intermediate Transfer Member

The intermediate transfer member according to the embodiment is preferably an endless belt that includes a substrate layer and an elastic layer. The term “endless” used herein refers conceptually (i.e., geometrically) to a loop-like shape formed by, for example, joining both edges of a long-length sheet-like body with each other.

The substrate layer of the intermediate transfer member includes a resin having a structural unit including a benzene ring, such as aromatic polyimide (PI), aromatic polyamide imide (PAI), polyphenylene sulfide (PPS), aromatic polyether ether ketone (PEEK), aromatic polycarbonate, or aromatic polyether ketone; polyvinylidene fluoride; a mixture or copolymer of the above resins; or the like.

Alternatively, the substrate layer of the intermediate transfer member may be a resin film, such as a polyethylene terephthalate (PET) film, a polyimide film, a 1,4-polycyclohexylenedimethylene terephthalate film, a polyethylene naphthalate (PEN) film, a polyphenylene sulfide film, a polystyrene (PS) film, a polypropylene (PP) film, a polysulfone film, an aramid film, a polycarbonate film, a polyvinyl alcohol film, a polyethylene (PE) film, a polyvinyl chloride film, a nylon film, a polyimide film, or an ionomer film, or may be composed of a cellulose derivative, such as cellophane or cellulose acetate.

The substrate layer may be composed of a material transparent to actinic radiation.

The intermediate transfer member preferably includes an elastic layer disposed on the side on which the ink is to be deposited. The elastic layer may include a rubber, such as a silicone rubber (SR), a chloroprene rubber (CR), a nitrile rubber (NBR), or an epichlorohydrin rubber (ECO), an elastomer, an elastic resin, or the like.

The intermediate transfer member may optionally include a surface layer including a fluororesin, such as polytetrafluoroethylene (PTFE), perfluoroalkoxy alkane (PFA), or polyvinylidene fluoride (PVDF), an acrylic resin, or the like.

The angle of contact of pure water on the surface of the intermediate transfer member is preferably 50° or less, is more preferably 40° or less, and is further preferably 20° or less. Setting the angle of contact of pure water on the surface of the intermediate transfer member to be 50° or less enables the precoat liquid to spread on the surface of the intermediate transfer member to a sufficient degree. The angle of contact of pure water may be measured at 20° C. in accordance with JIS R 3257 (1999).

### 4. Image Forming Method

An image forming method according to the embodiment of the present invention includes applying the precoat liquid onto the surface of the intermediate transfer member; applying the actinic radiation-curable ink onto the surface of the intermediate transfer member, the surface of the intermediate transfer member including the precoat liquid deposited thereon; transferring the actinic radiation-curable ink deposited on the surface of the intermediate transfer member to a recording medium; and curing the actinic radiation-curable ink transferred on the recording medium. Each of the above steps is described below.

### 4-1. Precoat Liquid Application Step

A precoat liquid application step is a step of applying the precoat liquid onto the surface of the intermediate transfer member to form a liquid precoat layer. In this embodiment, the precoat liquid is a water-soluble organic solvent having two or more hydroxyl groups per molecule and is preferably a water-soluble organic solvent having three or more hydroxyl groups per molecule. The C value of the water-soluble organic solvent which is calculated using Expression (1) below is larger than 0.03.

C=[Number of hydroxyl groups per molecule]²/[Molecular weight] (1)

For the application of the precoat liquid, known liquid coating methods, such as spray coating, spiral coating using a nozzle or a slit, dip coating, roll coating, gravure coating, and flexo coating, may be used. Since the precoat liquid has a high viscosity, the precoat liquid is preferably applied onto the entire surface of the intermediate transfer member with a roll coater coating method.

Applying the precoat liquid onto the entire surface of the intermediate transfer member before the actinic radiation-curable ink is applied onto the surface of the intermediate transfer member makes it easy to detach an intermediate image from the surface of the intermediate transfer member when the intermediate image is transferred to a recording medium.

### 4-2. Actinic Radiation-Curable Ink Application Step

An actinic radiation-curable ink application step is a step of applying the actinic radiation-curable ink onto the surface of the liquid precoat layer disposed on the surface of the intermediate transfer member to form an intermediate image.

The method for applying the actinic radiation-curable ink onto the surface of the liquid precoat layer is not limited; known methods, such as spray coating, dip coating, screen printing, gravure printing, offset printing, and an inkjet method, may be used. In this embodiment, an inkjet method in which the actinic radiation-curable ink is ejected through an inkjet head and applied onto the surface of the liquid precoat layer is preferably used in the step of applying the actinic radiation-curable ink onto the surface of the liquid precoat layer to form an intermediate image.

The inkjet head used in the inkjet method may be either a drop-on-demand inkjet head or a continuous inkjet head. Examples of the drop-on-demand inkjet head include electromechanical conversion-type inkjet heads, such as a single-cavity inkjet head, a double-cavity inkjet head, a vendor inkjet head, a piston inkjet head, a shear mode inkjet head, and a shared wall inkjet head; and electrothermal conversion-type inkjet heads, such as thermal inkjet head and a “Bubble Jet” inkjet head (“Bubble Jet” is a registered trademark of CANON KABUSHIKI KAISHA).

The inkjet head may be either a scanning inkjet head or a line inkjet head.

In order to increase ease of ejection of the droplets of the actinic radiation-curable ink, it is preferable to heat the actinic radiation-curable ink to 40° C. to 120° C. in the inkjet head and eject the heated actinic radiation-curable ink.

In the case where the actinic radiation-curable ink includes the gelling agent, it is preferable to set the temperature of the actinic radiation-curable ink contained in the inkjet head to be higher than the gelation temperature of the actinic radiation-curable ink by 10° C. or more and less than 40° C. Setting the temperature of the actinic radiation-curable ink contained in the inkjet head to be higher than the gelation temperature of the actinic radiation-curable ink by 10° C. or more prevents the actinic radiation-curable ink from undergoing gelation in the inkjet head or on the nozzle surface and enables the actinic radiation-curable ink to be ejected in a suitable manner. Setting the temperature of the actinic radiation-curable ink contained in the inkjet head to be higher than the gelation temperature of the actinic radiation-curable ink by less than 40° C. reduces the thermal load placed on the inkjet head. In the case where the inkjet head includes a piezoelectric element, it is particularly preferable to set the temperature of the actinic radiation-curable ink to fall within the above range because the performance of the inkjet head is particularly likely to become degraded by a thermal load.

In the case where the actinic radiation-curable ink includes the gelling agent, the pinning of the actinic radiation-curable ink deposited on the surface of the intermediate transfer member occurs as a result of the crystallization of the gelling agent. This further reduces the likelihood of spread of the dots formed by the actinic radiation-curable ink being applied to the intermediate transfer member and combining of the dots formed by the actinic radiation-curable ink being impinged on the surface of the intermediate transfer member.

In order to increase the degree of pinning of the actinic radiation-curable ink, the surface temperature of the intermediate transfer member may be adjusted to be substantially equal to or lower than the gelation temperature of the gelling agent.

### 4-3. Actinic Radiation-Curable Ink Transfer Step

An actinic radiation-curable ink transfer step is a step of transferring the actinic radiation-curable ink from the intermediate transfer member onto the surface of a recording medium. The image forming method according to the embodiment may further include a step of pressurizing the actinic radiation-curable ink deposited on the surface of the intermediate transfer member with a pressurizing member when the actinic radiation-curable ink is transferred to the recording medium. In the case where the image is pressurized, the temperature of the pressurizing member is preferably set to 20° C. or more and 90° C. or less and is more preferably set to 20° C. or more and 80° C. or less. Setting the temperature of the pressurizing member to fall within the above range enables the actinic radiation-curable ink to be transferred from the intermediate transfer member to the recording medium without degrading transferability even when the glass transition point Tg of the actinic radiation-curable ink is higher than room temperature.

### 4-4. Actinic Radiation-Curable Ink Curing Step

An actinic radiation-curable ink curing step is a step of irradiating the actinic radiation-curable ink (i.e., the intermediate image) transferred on the recording medium with actinic radiation (e.g., ultraviolet radiation) to completely cure the actinic radiation-curable ink (i.e., the intermediate image). Hereby, an intended high-definition image may be formed on the surface of the recording medium. The wavelength of the actinic radiation used in this step is preferably 350 to 450 nm and is more preferably 380 nm or more and less than 430 nm. Curing the actinic radiation-curable ink with the above actinic radiation enhances the fixability of the actinic radiation-curable ink to the recording medium.

The image forming method according to the embodiment of the present invention is not limited to the above-described image forming method. For example, the image forming method according to the embodiment may include a thickening step of irradiating the actinic radiation-curable ink with actinic radiation before or when the actinic radiation-curable ink is transferred to the recording medium in order to increase the viscosity of the actinic radiation-curable ink.

### 5 Image Forming Apparatus

FIGURE is a schematic diagram illustrating an example of the structure of inkjet image forming apparatus 100 according to the embodiment of the present invention.

Image forming apparatus 100 according to the embodiment includes intermediate transfer member 110, precoat liquid application unit 120 that applies the precoat liquid onto the surface of intermediate transfer member 110, ink application unit 130 that applies the actinic radiation-curable ink onto the surface of intermediate transfer member 100, the surface including the precoat liquid deposited thereon; and transfer unit 140 that transfers the actinic radiation-curable ink deposited on the surface of intermediate transfer member 100 to recording medium S. Image forming apparatus 100 further includes support rollers 150, 151, and 152 around which intermediate transfer member 110 having a shape of an endless belt is wound in a tensioned state; curing unit 170 that irradiates the surface of transport path 160 with actinic radiation in order to cure (completely cure) the actinic radiation-curable ink constituting an intermediate image; and cleaning unit 180 that removes the actinic radiation-curable ink that is not transferred to recording medium S and remains on the surface of intermediate transfer member 110 from the surface of intermediate transfer member 110.

The precoat liquid applied onto the surface of intermediate transfer member 110 is a water-soluble organic solvent having two or more hydroxyl groups per molecule and is preferably a water-soluble organic solvent having three or more hydroxyl groups per molecule. The C value of the water-soluble organic solvent which is calculated using Expression (1) below is larger than 0.03.

C=[Number of hydroxyl groups per molecule]²/[Molecular weight] (1)

Intermediate transfer member 110 is wound around support rollers 150, 151, and 152 in a tensioned state and rotates to transport an intermediate image, which is formed on the surface of intermediate transfer member 110 with intermediate image formation unit 131, to transfer unit 140.

At least one of the three support rollers 150, 151, and 152 is a driving roller that drives intermediate transfer member 110 to rotate in direction A.

Intermediate transfer member 110 includes a substrate layer. The substrate layer includes a resin having a structural unit including a benzene ring, such as aromatic polyimide (PI), aromatic polyimide imide (PAI), polyphenylene sulfide (PPS), aromatic polyether ether ketone (PEEK), aromatic polycarbonate, or aromatic polyether ketone; polyvinylidene fluoride; a mixture or copolymer of the above resins; or the like.

Alternatively, intermediate transfer member 110 may be a resin film, such as a polyethylene terephthalate (PET) film, a 1,4-polycyclohexylenedimethylene terephthalate film, a polyethylene naphthalate (PEN) film, a polyphenylene sulfide film, a polystyrene (PS) film, a polypropylene (PP) film, a polysulfone film, an aramid film, a polycarbonate film, a polyvinyl alcohol film, a polyethylene (PE) film, a polyvinyl chloride film, a nylon film, a polyimide film, or an ionomer film, or may be composed of a cellulose derivative, such as cellophane or cellulose acetate.

Intermediate transfer member 110 may be composed of a material transparent to actinic radiation (e.g., ultraviolet radiation).

Intermediate transfer member 110 preferably includes an elastic layer (not illustrated in the drawing) disposed on the side on which the ink is to be deposited. The elastic layer may include a rubber, such as a silicone rubber (SR), a chloroprene rubber (CR), a nitrile rubber (NBR), or an epichlorohydrin rubber (ECO), an elastomer, an elastic resin, or the like.

Intermediate transfer member 110 may optionally include a surface layer (not illustrated in the drawing) including a fluororesin, such as polytetrafluoroethylene (PTFE), perfluoroalkoxy alkane (PFA), or polyvinylidene fluoride (PVDF), an acrylic resin, or the like.

The angle of contact of pure water on the surface of intermediate transfer member 110 is preferably 50° or less, is more preferably 40° or less, and is further preferably 20° or less. Setting the angle of contact of pure water on the surface of intermediate transfer member 110 to be 50° or less enables the precoat liquid to spread on the surface of intermediate transfer member 110 to a sufficient degree. The angle of contact of pure water may be measured at 20° C. in accordance with JIS R 3257 (1999).

The surface of a portion of intermediate transfer member 110 which extends between support rollers 151 and 152, which are located at left and right vertices of the inverted triangle, in a tensioned state is the surface on which the actinic radiation-curable ink applied by the ink application unit 130 is to be impinged. Support roller 150, which is located at the lower vertex of the inverted triangle formed by intermediate transfer member 110, is a pressurizing roller that presses intermediate transfer member 110 against transport path 160 at a predetermined nip pressure and serves also as pressurizing unit 141 that transfers an intermediate image, which is formed by the actinic radiation-curable ink ejected from ink application unit 130, to recording medium S.

Precoat liquid application unit 120 includes roll coater 121 having a surface coated with a sponge and scraper 122. Roll coater 121 applies the precoat liquid onto the surface of intermediate transfer member 110. Scraper 122 removes an excess precoat liquid to make the surface of the precoat liquid deposited on the intermediate transfer member 110 flat and smooth. Consequently, the precoat liquid is deposited on the surface of intermediate transfer member 110 at a predetermined thickness to form a precoat layer. The precoat liquid application unit 120 may use a method in which a bar coater is used, an inkjet method, or the like.

In this embodiment, intermediate image formation unit 131, which serves also as ink application unit 130, is an ink application unit that forms an intermediate image by an inkjet method and includes inkjet heads 130Y, 130M, 130C, and 130K that ejects yellow (Y), magenta (M), cyan (C), and black (K) actinic radiation-curable compositions (i.e., inkjet inks), respectively, through nozzles to apply the compositions onto the surface of intermediate transfer member 110. Inkjet heads 130Y, 130M, 130C, and 130K form an intermediate image by applying the Y, M, C, and K actinic radiation-curable inks to the respective portions of the surface of intermediate transfer member 110 which correspond to the image that is to be formed.

Transfer unit 140 is located at the position at which intermediate transfer member 110 is closest to transport path 160. The surface of transport path 160 with which intermediate transfer member 110 is in contact is pressurized by intermediate transfer member 110 being pressed by support rollers 150, 151, and 152 against transport path 160. The intermediate image including the actinic radiation-curable ink, which is formed on the surface of intermediate transfer member 110 and transported to transfer unit 140, and recording medium S, which is placed on the surface of transport path 160 and transported to transfer unit 140, come into contact with each other in the transfer unit 140. The intermediate image is transferred from intermediate transfer member 110 to recording medium S by being pressed against transport path 160 with support roller 150.

Transport path 160 is composed of, for example, a metal drum and transports recording medium S onto which an intermediate image is to be transferred. Transport path 160 is arranged to be in contact with a part of the surface of intermediate transfer member 110. Transfer unit 140 is formed as a result of the above part of the surface of intermediate transfer member 110 being pressurized by support roller 150. Transport path 160 may include a claw (not illustrated in the drawing) that fixes the front end of recording medium S in position. Transport path 160 transports recording medium S to the transfer unit by fixing the front end of recording medium S to the claw and rotating in the counterclockwise direction in FIGURE.

Curing unit 170 is disposed downstream of transfer unit 140 in the direction in which recording medium S is transported by the transport path 160 and irradiates the surface of transport path 160 with actinic radiation (e.g., ultraviolet radiation). Thus, curing unit 170 irradiates the intermediate image transferred on recording medium S with actinic radiation to cure (completely cure) the actinic radiation-curable ink constituting the intermediate image. Consequently, an intended high-definition image may be formed on the surface of recording medium S.

Cleaning unit 180 is a cleaning roller, such as a web roller or a sponge roller and is arranged to be in contact with the surface of intermediate transfer member 110 at a position downstream of transfer unit 140. Upon the rotation of the cleaning roller, cleaning unit 180 removes the residual composition (residual coating) that is not transferred to recording medium S in transfer unit 140 and remains on the surface of intermediate transfer member 110.

Image forming apparatus 100 according to the embodiment may include a thickening unit that irradiates the actinic radiation-curable ink with actinic radiation before or when the actinic radiation-curable ink is transferred to the recording medium in order to increase the viscosity of the actinic radiation-curable ink.

Although an intermediate image is formed on the moving surface of the intermediate transfer member by an inkjet method in the above-described embodiment, the method for forming an intermediate image is not limited; known methods, such as spray coating, dip coating, screen printing, gravure printing, and offset printing, may be used.

### EXAMPLES

The present invention is described specifically with reference to Examples below. The present invention is not limited to Examples.

1. Preparation of Intermediate Transfer Member

1-1. Preparation of Substrate Layer

To an N-methyl-2-pyrrolidone (NMP) solution of polyamide acid “U-varnish-S” produced by Ube Industries, Ltd. (solid content: 18 mass %), which was prepared by the reaction of 3,3′,4,4′-biphenyltetracarboxylic dianhydride (BPDA) with p-phenylenediamine (PDA), dry oxidized carbon black “SPECIAL BLACK 4” produced by Degussa (pH: 3.0, volatile content: 14.0%) was added to form a mixture. The amount of the oxidized carbon black used was 23 parts by mass relative to 100 parts by mass of the solid content of the polyimide resin produced from the polyamide acid. The resulting mixture was subjected to a collision dispersing machine “GeanusPY” produced by Geanus and passed through a channel in which the mixture is divided into two, brought into collision with each other at a pressure of 200 MPa and a minimum area of 1.4 mm², and again divided into two. The mixture was passed through the channel five times and subsequently stirred. Hereby, a carbon black-containing polyamide acid solution was prepared.

The carbon black-containing polyamide acid solution was applied onto the inner surface of a cylindrical mold with a dispenser while the mold was rotated at 30 rpm for 15 minutes to form a cylindrical layer having a uniform thickness of 0.5 mm. Subsequently, hot air of 60° C. was applied from the outside of the mold to the mold, on which the carbon black-containing polyamide acid solution was deposited, for 30 minutes while the mold was rotated at 15 rpm. Then, the mold was heated at 150° C. for 60 minutes. Subsequently, the mold was heated to 360° C. at a heating rate of 2° C./min and then at 360° C. for 30 minutes to remove the solvent and dehydration ring-closure water. Hereby, an imide conversion reaction was completed. Subsequently, the mold was cooled to room temperature, and the cylindrical layer was detached from the mold. Hereby, an endless belt-like substrate layer having an overall thickness of 0.1 mm was prepared.

1-2. Preparation of Elastic Layer

While stirring was performed, equal parts of the liquids A and B of a liquid silicone rubber “KE-2060-30” produced by Shin-Etsu Chemical Co., Ltd. were mixed with each other to form a liquid silicone rubber solution. While the endless belt-like substrate was rotated at 1 rpm, the liquid silicone rubber solution was fed onto the outer surface of the substrate with a dispenser in a helical pattern to form a coating film having a thickness of 0.5 mm. While the substrate was rotated, hot air of 120° C. was applied to the substrate for 5 minutes to perform primary curing. Subsequently, the temperature was increased to 200° C. and heating was performed for 60 minutes. Hereby, an endless belt including an elastic layer disposed thereon was prepared.

1-3. Preparation of Surface-Treating Agent Solution

Acetic acid was added to ion-exchange water to prepare a solution having a pH of 4. To 100 parts by mass of the above solution, 2 parts by mass of methoxypolyethylenoxy(6-9)propyltrimethoxysilane “SIM6492.7” produced by Gelest, Inc., which is a surface-treating agent having a hydrophilic functional group, was slowly added dropwise. The resulting mixture was stirred for one hour, and it was confirmed that the surface-treating agent had been completely dissolved. Hereby, a surface-treating agent solution was prepared.

1-4. Preparation of Intermediate Transfer Member

While the endless belt including an elastic layer was rotated at 100 mm/s, it was subjected to a corona discharge treatment using a corona discharge device produced by KASUGA DENKI, INC. at 350 mW.

Immediately subsequent to the corona discharge treatment, the surface-treating agent solution was applied onto the surface of the endless belt with a spray nozzle so as to spread over the entire surface of the belt. The belt was then dried by heating at 120° C. for 60 minutes. Subsequently, the surface of the belt was cleaned with ion-exchange water and dried. Then, aging was performed for 12 hours. Hereby, an intermediate transfer member was prepared. The angle of contact of pure water on the surface of the intermediate transfer member measured at 20° C. in accordance with JIS R 3257 (1999) was 16°.

1-5. Preparation of Precoat Liquid

1-5-1. Precoat Liquid 1

With 99 parts by mass of pure water, 1 part by mass of polyoxyethylene alkyl ether (surfactant) was mixed to form a diluted solution. With 100 parts by mass of glycerin, 1 part by mass of the diluted solution was mixed to prepare a precoat liquid 1. The C value of the precoat liquid 1 was 0.0977.

1-5-2. Precoat Liquid 2

With 99 parts by mass of pure water, 1 part by mass of polyoxyethylene alkyl ether was mixed to form a diluted solution. With 100 parts by mass of diglycerin, 1 part by mass of the diluted solution was mixed to prepare a precoat liquid 2. The C value of the precoat liquid 2 was 0.0963.

1-5-3. Precoat Liquid 3

With 99 parts by mass of pure water, 1 part by mass of polyoxyethylene alkyl ether was mixed to form a diluted solution. With 100 parts by mass of polyglycerin, 1 part by mass of the diluted solution was mixed to prepare a precoat liquid 3. The C value of the precoat liquid 3 was 0.1041.

1-5-4. Precoat Liquid 4

With 99 parts by mass of pure water, 1 part by mass of polyoxyethylene alkyl ether was mixed to form a diluted solution. With 100 parts by mass of propylene glycol, 1 part by mass of the diluted solution was mixed to prepare a precoat liquid 4. The C value of the precoat liquid 4 was 0.0526.

1-5-5. Precoat Liquid 5

With 99 parts by mass of pure water, 1 part by mass of polyoxyethylene alkyl ether was mixed to form a diluted solution. With 100 parts by mass of 1,3-propanediol, 1 part by mass of the diluted solution was mixed to prepare a precoat liquid 5. The C value of the precoat liquid 5 was 0.0526.

1-5-6. Precoat Liquid 6

With 99 parts by mass of pure water, 1 part by mass of polyoxyethylene alkyl ether was mixed to form a diluted solution. With 100 parts by mass of 1,5-pentanediol, 1 part by mass of the diluted solution was mixed to prepare a precoat liquid 6. The C value of the precoat liquid 6 was 0.0384.

1-5-7. Precoat Liquid 7 With 99 parts by mass of pure water, 1 part by mass of polyoxyethylene alkyl ether was mixed to form a diluted solution. With 100 parts by mass of methanol, 1 part by mass of the diluted solution was mixed to prepare a precoat liquid 7. The C value of the precoat liquid 7 was 0.0313.

1-5-8. Precoat Liquid 8

With 99 parts by mass of pure water, 1 part by mass of polyoxyethylene alkyl ether was mixed to form a diluted solution. With 100 parts by mass of polyethylene glycol, 1 part by mass of the diluted solution was mixed to prepare a precoat liquid 8. The C value of the precoat liquid 8 was 0.0200.

1-5-9. Precoat Liquid 9

With 99 parts by mass of pure water, 1 part by mass of polyoxyethylene alkyl ether was mixed to form a diluted solution. With 100 parts by mass of dipropylene glycol, 1 part by mass of the diluted solution was mixed to prepare a precoat liquid 9. The C value of the precoat liquid 9 was 0.0298.

1-5-10. Precoat Liquid 10

With 99 parts by mass of pure water, 1 part by mass of polyoxyethylene alkyl ether was mixed to form a diluted solution. With 100 parts by mass of a silicone oil, 1 part by mass of the diluted solution was mixed to prepare a precoat liquid 10. The C value of the precoat liquid 10 was 0.0.

1-5-11. Precoat Liquid 11

With 99 parts by mass of pure water, 1 part by mass of polyoxyethylene alkyl ether was mixed to form a diluted solution. With 100 parts by mass of liquid paraffin, 1 part by mass of the diluted solution was mixed to prepare a precoat liquid 11. The C value of the precoat liquid 11 was 0.0.

1-5-12. Precoat Liquid 12 With 99 parts by mass of pure water, 1 part by mass of polyoxyethylene alkyl ether was mixed to form a diluted solution. With 100 parts by mass of 1-pentanol, 1 part by mass of the diluted solution was mixed to prepare a precoat liquid 12. The C value of the precoat liquid 12 was 0.0114.

1-6. Measurement of Surface Tension

The surface tension of each of the precoat liquids 1 to 12 was measured by the following method. Specifically, the surface tension of each of the precoat liquids 1 to 12 was calculated as r=F/(L cos θ), where F [mN] is the force required for vertically holding a platinum plate at 23° C. such that the lower end of the plate was in contact with the precoat liquid, L [m] is the peripheral length of a portion of the platinum plate which was in contact with the precoat liquid, and θ is the angle of contact of the platinum plate with the precoat liquid.

Table 1 summarizes the C value and surface tension of each of the precoat liquids 1 to 12.

TABLE 1

| | | | Number | | |
|---|---|---|---|---|---|
| | Water-soluble | | of | | |
| Precoat | organic | | hydroxyl | C | Surface |
| liquid | solvent | Structure | groups | value | tension |
| 1 | Glycerin | General | 3 | 0.0977 | 48 mN/m |
| | | Formula (1) | | | |
| 2 | Diglycerin | General | 4 | 0.0963 | 45 mN/m |
| | | Formula (1) | | | |
| 3 | Polyglycerin | General | 5 | 0.1041 | 39 mN/m |
| | | Formula (1) | | | |
| 4 | Propylene | General | 2 | 0.0526 | 28 mN/m |
| | glycol | Formula (2) | | | |
| 5 | 1,3-Propanediol | General | 2 | 0.0526 | 40 mN/m |
| | | Formula (2) | | | |
| 6 | 1,5-Pentanediol | General | 2 | 0.0384 | 36 mN/m |
| | | Formula (2) | | | |
| 7 | Methanol | — | 1 | 0.0313 | 23 mN/m |
| 8 | Polyethylene | General | 2 | 0.0200 | 38 mN/m |
| | glycol | Formula (2) | | | |
| 9 | Dipropylene | General | 2 | 0.0298 | 26 mN/m |
| | glycol | Formula (2) | | | |
| 10 | Silicone oil | — | — | 0.0 | 19 mN/m |
| 11 | Liquid paraffin | — | — | 0.0 | 26 mN/m |
| 12 | 1-Pentanol | — | 1 | 0.0114 | 26 mN/m |

2. Preparation of Actinic Radiation-Curable Ink

An actinic radiation-curable ink was prepared in the following manner.

2-1. Preparation of Pigment Dispersion

Into a stainless steel beaker, 9.0 parts by mass of a pigment dispersant “AJISPER PB824” produced by Ajinomoto Fine-Techno Co., Inc. (“AJISPER” is a registered trademark of Ajinomoto Co., Inc.), 70.0 parts by mass of an actinic radiation-polymerizable compound (tripropylene glycol diacrylate), and 0.02 parts by mass of a polymerization inhibitor “Irgastab UV10” produced by BASF SE (“Irgastab” is a registered trademark of BASF SE) were charged. While the beaker was heated with a hot plate at 65° C., stirring was performed for 1 hour.

After the resulting liquid mixture was cooled to room temperature, 21.0 parts by mass of Pigment Red 122 (“CHROMOFINE RED 6112JC” produced by Dainichiseika Color & Chemicals Mfg. Co., Ltd.) was added to the liquid mixture. Subsequently, the liquid mixture and 200 g of zirconia beads having a diameter of 0.5 mm were charged into a glass bottle, which was then hermetically sealed. Subsequently, a dispersion treatment was performed with a paint shaker for 8 hours. The zirconia beads were removed from the resulting dispersion. Hereby, a pigment dispersion was prepared.

2-2. Preparation of Actinic Radiation-Curable Ink

Into a stainless steel beaker, 5.0% by mass of a gelling agent “LUNAC BA” produced by Kao Corporation (behenic acid, “LUNAC” is a registered trademark of Kao Corporation), 29.9% by mass of an actinic radiation-polymerizable compound (polyethylene glycol #400 diacrylate), 23.0% by mass of 6EO-modified trimethylolpropane triacrylate, 15.0% by mass of 4EO-modified pentaerythritol tetraacrylate, 6.0% by mass of a polymerization initiator “DAROCUR TPO” produced by BASF SE (“DAROCUR” is a registered trademark of BASF SE), 1.0% by mass of a polymerization initiator “ITX” produced by DKSH Japan K. K., 1.0% by mass of a polymerization initiator “DAROCUR EDB” produced by BASF SE, 0.1% by mass of a surfactant “KF-352” produced by Shin-Etsu Chemical Co., Ltd., and 19.0% by mass of the above pigment dispersion were charged. While the beaker was heated with a hot plate at 80° C., stirring was performed for 1 hour. While the resulting solution was heated, the solution was passed through a 3-μm Teflon (registered trademark) membrane filter produced by Advantec Toyo Kaisha, Ltd. to prepare an actinic radiation-curable ink.

3. Evaluations

An image was formed using the intermediate transfer member on which a specific one of the precoat liquids 1 to 12 was deposited and evaluated in terms of dot sharpness and transferability.

3-1. Dot Sharpness Evaluation

Evaluation Method

While recording media were fed to the image forming apparatus at a speed of 600 mm/s, 10 solid images having a size of 30 cm×30 cm and a 10% halftone image having a size of 30 cm×30 cm were formed. The shape of the dots constituting the halftone part was observed.

Evaluation Standards

A: The dots had a clear outline.

B: The dots had a blurred outline, but it was acceptable for practical use.

C: The dots had an unclear outline, and it was not acceptable for practical use.

3-2. Transferability Evaluation

Evaluation Method

While recording media were fed to the image forming apparatus at a speed of 600 mm/s, 10 solid images having a size of 30 cm×30 cm and a 10% cyan halftone image having a size of 30 cm×30 cm were formed. Whether the halftone image was transferred to the recording media “OK Top Coat” (128 g/m²) produced by Oji Paper Co., Ltd. was visually determined.

A: 90% or more of the dots were transferred.

B: 70% or more and less than 90% of the dots were transferred.

C: The dots were not transferred since the ink droplets were ruptured.

Table 2 summarizes the evaluation results.

TABLE 2

| Precoat | Water-soluble | Dot | | |
|---|---|---|---|---|
| liquid | organic solvent | sharpness | Transferability | Remarks |
| 1 | Glycerin | A | A | Example |
| 2 | Diglycerin | A | A | Example |
| 3 | Polyglycerin | A | A | Example |
| 4 | Propylene glycol | B | A | Example |
| 5 | 1,3-Propanediol | A | A | Example |
| 6 | 1,5-Pentanediol | B | B | Example |
| 7 | Methanol | C | C | Comparative |
| | | | | example |
| 8 | Polyethylene glycol | B | C | Comparative |
| | | | | example |
| 9 | Dipropylene glycol | B | C | Comparative |
| | | | | example |
| 10 | Silicone oil | C | C | Comparative |
| | | | | example |
| 11 | Liquid paraffin | C | C | Comparative |
| | | | | example |
| 12 | 1-Pentanol | C | C | Comparative |
| | | | | example |

The results of evaluation of the sharpness of ink dots confirm that using a water-soluble organic solvent having two or more hydroxyl groups per molecule and a C value of 0.03 or more as a precoat liquid reduced the compatibilization of the precoat liquid with the actinic radiation-curable ink and enhanced transferability. This is because the reduction in the compatibilization of the precoat liquid with the actinic radiation-curable ink prevented excessive spread of the actinic radiation-curable ink. Specifically, excessive spread of the actinic radiation-curable ink which may occur when the actinic radiation-curable ink is applied onto the surface of the precoat liquid was prevented. It is considered that this enabled a high-definition image to be formed with high transferability.

### INDUSTRIAL APPLICABILITY

A high-definition image may be formed with high transferability by using the precoat liquid according to the present invention. Therefore, it is anticipated that the present invention widen the range of applications of an intermediate transfer image forming method in which an actinic radiation-curable ink is used and contribute to the progress and proliferation of the technology in this field.

Although embodiments of the present invention have been described and illustrated in detail, the disclosed embodiments are made for purposes of illustration and example only and not limitation. The scope of the present invention should be interpreted by terms of the appended claims

What is claimed is:

1. A precoat liquid used in an intermediate-transfer image forming method in which an actinic radiation-curable ink and an intermediate transfer member are used, the precoat liquid being applied onto a surface of the intermediate transfer member before the actinic radiation-curable ink is applied onto the surface of the intermediate transfer member, the precoat liquid comprising:
a water-soluble organic solvent having two or more hydroxyl groups per molecule,
the water-soluble organic solvent having a C value of more than 0.03, the C value being calculated using Expression (1) below
C=[Number of hydroxyl groups per molecule]²/[Molecular weight] (1).

2. The precoat liquid according to claim 1,
wherein the water-soluble organic solvent has three or more hydroxyl groups per molecule.

3. The precoat liquid according to claim 1,
wherein the water-soluble organic solvent has a structure represented by General Formula (1) below, 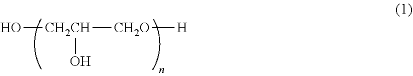
wherein, in General Formula (1), n represents a degree of polymerization and is an integer of 1 to 10.

4. The precoat liquid according to claim 3,
wherein the water-soluble organic solvent having the structure represented by General Formula (1) has a degree of polymerization of 5 or less.

5. The precoat liquid according to claim 1,
wherein the water-soluble organic solvent has a structure represented by General Formula (2) below,
HO—R—OH (2)
wherein, in General Formula (2), R is a linear or branched alkyl group having 2 to 6 carbon atoms or a linear or branched alkyl group having 2 to 6 carbon atoms and an ether group.

6. The precoat liquid according to claim 1,
wherein the precoat liquid has a surface tension of 30 mN/m or more and 70 mN/m or less.

7. An image forming method, comprising:
applying a precoat liquid onto a surface of an intermediate transfer member;
applying an actinic radiation-curable ink onto the surface of the intermediate transfer member, the surface of the intermediate transfer member including the precoat liquid deposited thereon;
transferring the actinic radiation-curable ink deposited on the surface of the intermediate transfer member to a recording medium; and
curing the actinic radiation-curable ink transferred on the recording medium,
wherein the precoat liquid includes a water-soluble organic solvent having two or more hydroxyl groups per molecule, and
wherein the water-soluble organic solvent has a C value of more than 0.03, the C value being calculated using Expression (1) below
C=[Number of hydroxyl groups per molecule]²/[Molecular weight] (1).

8. The image forming method according to claim 7,
wherein the actinic radiation-curable ink includes a (meth)acrylate.

9. The image forming method according to claim 7,
wherein the actinic radiation-curable ink has a solubility parameter of 15 or more and less than 20.

10. The image forming method according to claim 7,
wherein an angle of contact of pure water on the surface of the intermediate transfer member is 50° or less.

11. The image forming method according to claim 7,
wherein the intermediate transfer member includes a substrate layer and an elastic layer.

12. An image forming apparatus, comprising:
an intermediate transfer member;
a precoat liquid application unit that applies a precoat liquid onto a surface of the intermediate transfer member;
an ink application unit that applies an actinic radiation-curable ink onto the surface of the intermediate transfer member, the surface of the intermediate transfer member including the precoat liquid deposited thereon;
a transfer unit that transfers the actinic radiation-curable ink deposited on the surface of the intermediate transfer member to a recording medium; and
a fixing unit that cures the actinic radiation-curable ink transferred on the recording medium,
wherein the precoat liquid includes a water-soluble organic solvent having two or more hydroxyl groups per molecule, and
wherein the water-soluble organic solvent has a C value of more than 0.03, the C value being calculated using Expression (1) below
C=[Number of hydroxyl groups per molecule]²/[Molecular weight] (1).
